(19) United States
(12) Patent Application Publication
(10) Pub. No.: US 2023/0267525 A1
(43) Pub. Date: Aug. 24, 2023

(54) SITUATIONALLY AWARE MOBILE DEVICE FOR AUTOMATED RESOURCE ANALYSIS

(71) Applicant: BANK OF AMERICA CORPORATION, Charlotte, NC (US)

(72) Inventor: Shailendra Singh, Maharashtra (IN)

(73) Assignee: BANK OF AMERICA CORPORATION, Charlotte, NC (US)

(21) Appl. No.: 17/676,409

(22) Filed: Feb. 21, 2022

(51) Int. Cl. G06Q 30/06; G06V 20/20; G06F 3/147; G06V 10/82; G06K 7/10; G02B 27/01

(52) U.S. Cl. CPC G06Q 30/0631; G06V 20/20; G06F 3/147; G06V 10/82; G06K 7/10297; G06K 7/10366; G02B 27/0172; H04B 5/0062

(57) ABSTRACT

Embodiments of the invention are directed to systems, methods, and computer program products for a situationally aware mobile device which can provide a user with intelligent recommendations and information regarding nearby products based on a number of data points, including, but not limited to, neural network image analysis determinations, user resource account parameters, merchant offers, resource institution offers, and device comparison statistics.

### FIELD

The present invention generally relates to systems, products, and methods which utilize augmented reality for situationally aware resource analysis.

### BACKGROUND

With the advent of augmented reality devices and virtual reality devices becoming increasingly prevalent, accessible, and cross-compatible, there is an opportunity to leverage the capabilities of such devices in order to enhance user environments and streamline information access in number of contexts, including remote-customer contexts. There is a need for a system and methods which integrate with a user's normal daily experiences in order to provide streamlined recommendations for resource allocation and product comparison.

### BRIEF SUMMARY

The following presents a summary of certain embodiments of the invention. This summary is not intended to identify key or critical elements of all embodiments nor delineate the scope of any or all embodiments. Its sole purpose is to present certain concepts and elements of one or more embodiments in a summary form as a prelude to the more detailed description that follows.

Embodiments of the present invention address the above needs and/or achieve other advantages by providing apparatuses (e.g., a system, computer program product and/or other devices) and methods for a situationally aware mobile device which can provide a user with intelligent recommendations and information regarding nearby products based on a number of data points, including, but not limited to, neural network image analysis determinations, user resource account parameters, merchant offers, resource institution offers, and device comparison statistics. The invention describes an intelligent smart glass that proactively monitor and track users' resource goal against their potential shopping in real time. The invention may advise the user whether the user should buy products based on their resource goals. It also suggests offers for payment of products in real time and may execute payment on acceptance.

The method consists of smart glass-based vision sensing technology which analyze products while the user is viewing products in a shopping context. Deep learning image classification engines identify consumer products, and their brand, based on received image data from a sensor on a user device, and generates advisory notifications to the user in real time. Data feeds from smart glass are send to a resource advisory engine, and an offer generation engine, wherein on real time system analyze customer's potential buying with their current resource goals. The invention may also suggest offers in real time based on merchant or entity system offers, and execute payment or resource transfer on acceptance via the smart glass or intelligent user device. The user can pair their smart glasses with other smart glasses to form a local network or group to share information on offers, or the like, in real time, and can also execute payment to some other user.

Aspects of the invention described herein provide an innovative solution for augmenting user environments to provide an enhanced or dynamic environment no matter the user's particular physical location, and depending on the user's preferences or situational requirements. The invention provides a user experience that may be both more enjoyable and more productive than conventional remote environments, and may also allow for increased efficiency through the use of intelligent gesturing, predictive adaptability, and the use of deep-learning. As such, the system allows for dynamic response to user input, user preferences, user data patterns, application data, resource account data, or situational demands.

For instance, through the use of augmented reality systems, it is conceivable that the user's environment may be transformed via the use of virtual information overlay. In some embodiments, this may comprise a digitization of the user's surrounding spatial environment through the overlay of particular environmental features on the user's actual surroundings (e.g., an informational overlay, or the like). In some embodiments, this may allow for increased consistency in remote customer experience, no matter the location of the user.

In other embodiments, this same technology can be used to provide visual indications of certain information such as pricing, purchase offers, resource recommendations, product comparisons, product reviews, or the like, by rendering a dynamic view of one or more pieces of information, showing the user a visual representation of information that is not readily available in physical reality (i.e., augmenting the user's viewable information). The user may be able to quickly scan the virtual environment and receive important information regarding pricing, product comparisons, or the like. In still further embodiments, the system may be utilized to improve the ergonomics of the user's space in order to not only increase efficiency and productivity, but also provide increased convenience and accessibility to allow the user to more easily complete various tasks.

For sample, illustrative purposes, system environments will be summarized. Generally the invention may comprise the steps of: continuously monitor received image data or wireless frequencies to identify one or more products in a user's environment; transmit instructions to a user device to display information related to the product on an augmented reality display; identify a resource amount for the product; compare the resource amount for the product with a resource amount in one or more resource accounts of a user; generate a recommendation to purchase the product or refrain from purchasing the product; and transmit the recommendation to the user device for display to the user.

In some embodiments, the received image data is analyzed using a generative adversarial network in order to identify a specific product by inference from its visual characteristics.

In some embodiments, wireless frequencies further comprise a near-field communication signal or a radio frequency identifier signal emitted from the one or more products in the user's environment.

In some embodiments, the invention further comprises monitoring a local network or the user's vicinity for other user devices; identifying one or more other user devices in the user's vicinity; requesting information from the one or more other user devices related to the product; determining an average resource amount for the product; and comparing the average resource amount for the product to a current resource amount for the product.

In some embodiments, the augmented reality display is an augmented reality system comprising a pair of glasses projecting an image directly in the user's line of sight.

In some embodiments, comparing the resource amount for the product with a resource amount in one or more resource accounts of a user further comprises identifying an amount of resources that the user has available based on resource transaction history and recurring resource transactions over a time period.

In some embodiments, generating a recommendation to purchase the product or refrain from purchasing the product further comprises identifying an alternative product of a different brand or model which the user has enough available resources to buy.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 provides a diagram illustrating a system environment, in accordance with an embodiment of the invention;

FIG. 2 provides a block diagram illustrating various components of a managing entity system, in accordance with an embodiment of the invention;

FIG. 3 provides a block diagram illustrating various components of an augmented display system, in accordance with an embodiment of the invention;

FIG. 4 provides a block diagram illustrating various components of a user device, in accordance with embodiments of the invention; and

FIG. 5 provides a process flow 500 for providing a dynamically augmented display overlay, in accordance with embodiments of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

“Entity” or “managing entity” as used herein may refer to any organization, entity, or the like that may have one or more employees or administrators who utilize the described system, or in some cases who are responsible for managing or configuring the described system (e.g., configuring user-specific features, authorized access, or the like). In some embodiments, this may include commercial banks, thrifts, federal and state savings banks, savings and loan associations, credit unions, investment companies, insurance companies, software companies, or the like. In some embodiments, the entity may allow a user to establish an account with the entity. An “account” may be the relationship that the user has with the entity. Examples of accounts include a deposit account, such as a transactional account (e.g., a banking account), a savings account, an investment account, a money market account, a time deposit, a demand deposit, a pre-paid account, a credit account, or the like. The account is associated with and/or maintained by the entity. In other embodiments, an entity may not be a financial institution. In still other embodiments, the entity may be a merchant, or other kind of commercial entity.

“Entity system” or “managing entity system” (such as managing entity system 200) as used herein may refer to the computing systems, devices, software, applications, communications hardware, and/or other resources used by the entity to perform the functions as described herein, or used to control or configure the described systems and its components. Accordingly, the entity system may comprise desktop computers, laptop computers, servers, Internet-of-Things (“IoT”) devices, networked terminals, mobile smartphones, auxiliary devices, smart devices (e.g., smart watches), network connections, and/or other types of computing systems or devices and/or peripherals along with their associated applications.

As described herein, a “user” may be an individual associated with an entity. As such, in some embodiments, the user may be an individual having past relationships, current relationships or potential future relationships with an entity. In some embodiments, a “user” may be an employee (e.g., an associate, a project manager, an administrator, an engineer, a manager, an analyst, or the like) of the entity or enterprises affiliated with the entity, capable of operating the systems described herein. In some embodiments, a “user” may be any individual, entity or system who has a relationship with the entity, such as a customer or a prospective customer. In other embodiments, a user may be representative of a system performing one or more tasks described herein. In still further embodiments, a user may representative of one or more entities given access to the described systems as a service, such as a third party system user, or the like.

As used herein, a “user interface” may be any device or software that allows a user to input information, such as commands or data, into a device, or that allows the device to output information to the user. For example, the user interface may include a graphical user interface (GUI), or an interface to input computer-executable instructions that direct a processing device to carry out specific functions. The user interface typically employs certain input and output devices to input data received from a user second user or output data to a user. These input and output devices may include a display, mouse, keyboard, button, touchpad, touch screen, microphone, speaker, LED, light, joystick, switch, buzzer, bell, headset, and/or other user input/output device for communicating with one or more users. In some embodiments, the user interface may be a combination of devices which interface to provide an augmented display experience. For instance, the user may wear an augmented reality (AR) or virtual reality (VR) headset, also referred to herein as the augmented reality (AR) system, which interfaces with one or more other displays or devices in order to provide an overlay of additional information. In some embodiments, the user interface may be tailored to a specific user's role, access permissions, preferences, or the like, as described herein. In some embodiments, the AR system may be one or more devices that operate to display a projection to one or more users. For instance, in some embodiments, as opposed to the user wearing a headset or other device, an augmented visual overlay of the user's surroundings may be presented using a holographic projection viewable to multiple users at once. In some embodiments, one or more AR systems, whether headset or projection-type systems, may operate in cooperation with a back-end augmented display system to receive device-specific or user-specific information. For instance, the augmented display system may transmit different perspective views to different areas, users, or the like, or may alter the perspective view of the visual overlay based on a known position of one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning, or the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, and/or one or more devices, nodes, clusters, or systems within the system environment described herein. For example, an interaction may refer to a transfer of data between devices, an accessing of stored data by one or more nodes of a computing cluster, a transmission of a requested task, or the like.

As used herein, a “resource” may generally refer to objects, products, devices, goods, commodities, services, or the like, and/or the ability and opportunity to access and use the same. Some example implementations herein contemplate a market value of a property held by a user, including property that is stored and/or maintained by a third-party entity. For purposes of this invention, a resource is typically stored in a resource repository - a storage location where one or more resources are organized, stored, and retrieved electronically using a computing device.

Embodiments of the present invention provide apparatuses (e.g., a system, computer program product and/or other devices) and methods for a situationally aware mobile device which can provide a user with intelligent recommendations and information regarding nearby products based on a number of data points, including, but not limited to, neural network image analysis determinations, user resource account parameters, merchant offers, resource institution offers, and device comparison statistics. The invention describes an intelligent smart glass that proactively monitor and track users' resource goal against their potential shopping in real time. The invention may advise the user whether the user should buy products based on their resource goals. It also suggests offers for payment of products in real time and may execute payment on acceptance.

The method consists of smart glass-based vision sensing technology which analyze products while the user is viewing products in a shopping context. Deep learning image classification engines identify consumer products, and their brand, based on received image data from a sensor on a user device, and generates advisory notifications to the user in real time. Data feeds from smart glass are send to a resource advisory engine, and an offer generation engine, wherein on real time system analyze customer's potential buying with their current resource goals. The invention may also suggest offers in real time based on merchant or entity system offers, and execute payment or resource transfer on acceptance via the smart glass or intelligent user device. The user can pair their smart glasses with other smart glasses to form a local network or group to share information on offers, or the like, in real time, and can also execute payment to some other user.

Aspects of the invention described herein provide an innovative solution for augmenting user environments to provide an enhanced or dynamic environment no matter the user's particular physical location, and depending on the user's preferences or situational requirements. The invention provides a user experience that may be both more enjoyable and more productive than conventional remote environments, and may also allow for increased efficiency through the use of intelligent gesturing, predictive adaptability, and the use of deep-learning. As such, the system allows for dynamic response to user input, user preferences, user data patterns, application data, resource account data, or situational demands.

For instance, through the use of augmented reality systems, it is conceivable that the user's environment may be transformed via the use of virtual information overlay. In some embodiments, this may comprise a digitization of the user's surrounding spatial environment through the overlay of particular environmental features on the user's actual surroundings (e.g., an informational overlay, or the like). In some embodiments, this may allow for increased consistency in remote customer experience, no matter the location of the user.

In other embodiments, this same technology can be used to provide visual indications of certain information such as pricing, purchase offers, resource recommendations, product comparisons, product reviews, or the like, by rendering a dynamic view of one or more pieces of information, showing the user a visual representation of information that is not readily available in physical reality (i.e., augmenting the user's viewable information). The user may be able to quickly scan the virtual environment and receive important information regarding pricing, product comparisons, or the like. In still further embodiments, the system may be utilized to improve the ergonomics of the user's space in order to not only increase efficiency and productivity, but also provide increased convenience and accessibility to allow the user to more easily complete various tasks.

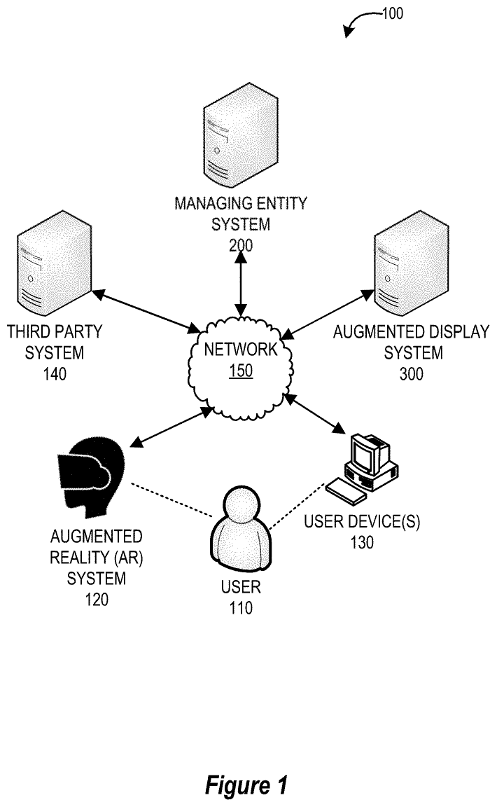

FIG. 1 provides a diagram illustrating a system environment, in accordance with an embodiment of the invention. As illustrated in FIG. 1, the system environment 100 includes a managing entity system 200, an augmented display system 300, one or more user device(s) 130, an augmented reality (AR) System 120, and one or more third party systems 140. One or more users 110 may also be included in the system environment 100 for representative purposes. In some embodiments, the user(s) 110 of the system environment 100 may be customers of a managing entity that owns or otherwise controls the augmented display system 300 which may, in some embodiments, comprise a financial institution. In other embodiments, the user(s) 110 may be employees of a managing entity.

The managing entity system 200, the augmented display system 300, the one or more user device(s) 130, the AR system 120, and/or the third party system 140 may be in network communication across the system environment 100 through the network 150. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet. In some embodiments, the AR system 120 may be in connection with the network 150 only when the AR system 120 is at a certain interaction distance from one or more user device(s) 130. In this way, the AR system 120 may interact with the other systems and devices of the environment via one or more user device(s) 130. In other embodiments, the AR system 120 may be in separate connection with the augmented display system 300 or the managing entity system 200, wherein the augmented display system 300 or the managing entity system 200 is transmitting instructions to control the display interface of one or more user device(s) 130 and the AR system 120 in concert.

The managing entity system 200 may be a system owned or otherwise controlled by a managing entity to perform one or more process steps described herein. In some embodiments, the managing entity is a financial institution. In general, the managing entity system 200 is configured to communicate information or instructions with the augmented display system 300, the one or more user device(s) 130, and/or the third party system 140 across the network 150. For example, the managing entity system 200 may maintain account data for the user 110 and therefore may receive a transaction request or other event request associated with the user 110 (e.g., via a third party system 140 comprising a merchant system), compare received information to an internal database of a user associated with the user 110, and transmit authentication or other approval information to the augmented display system 300, the third party system 140, the user device 130, or the like. The augmented display system 300 may be a system owned or controlled by the managing entity and/or a third party that specializes resource management, resource exchange hosting, user authentication systems, data management, systems engineering, IT support, or the like. In some embodiments, at least a portion of the augmented display system 300 may be controlled by or otherwise be a component of the managing entity system 200.

For example, the augmented display system 300 may provide an augmented display for a shopping experience. In some embodiments, augmented display system 300 provides additional tailored, user-specific detail as a user is viewing a product in a store. In some embodiments, a user may view an interface which contains a list of products, merchants, prices of products at particular merchants, reviews, actual prices other users paid for the same products, a comparison of monthly budget for the user with the price of the product, financing options for the product, or the like, and the augmentation may provide metadata or details that a user would typically have use an external system to look up, or would typically need to conduct multiple physical actions (e.g., clicks, right-clicks, taps, or the like) in order to access this additional information.

Each AR system 120, such as specialized glasses, goggles, or the like, may be unique to the user based on the user's role, position, or context. In other embodiments, the user may be required to log into a specific user account associated with the AR system 120 using authentication credentials, and the specific user account may be unique to the user based on the user's role, resource account, or the like. As such, the detailed or metadata displayed may be different based on the user viewing the screen, depending on their resource savings goals, available resources for purchases or the like.

The user device 130 may be a system owned or controlled by the managing entity, the user 110, and/or a third party that specializes in providing computers, mobile devices, or the like. In general, the user device 130 is configured to communicate information or instructions with the managing entity system 200, the augmented display system 300, the AR System 120, and/or the third party system 140 across the network 150. For example, the user device 130 may detect an interaction with the AR system 120, extract resource management information, transmit the resource information to the managing entity system 200 and/or the augmented display system 300, and receive a confirmation or responses from the augmented display system 300. In other embodiments, the AR system 120 may interface with the augmented display system 300 in order to receive user configuration data unique to the particular user logged into the system and using it at the current time. In this way, the same AR system 120 may be used to load multiple user configurations remotely via the augmented display system 300 such that it can be used by multiple different users (e.g., multiple users may share an AR system 120 and alternate using the AR system 120 in a given time period, but may load their specific preferences and account details stored on the augmented display system 300 or entity system 200). It is also understood that the AR system 120 contains the processing power and capability to conduct remote edge computing, meaning that even though many of the machine learning and neural network analysis described above occurs on the augmented display system 300, the AR system 120 itself may share or be in control of any of these processes locally on-device in order to provide the user with more immediate feedback. However, the AR system 120 may request certain information, such as up-to-date product information, resource account information, merchant information, or the like from the backend augmented display system 300, or managing entity system 200.

The AR system 120 may comprise any device, system, set of devices, or the like that is configured to generate an experience taking place within simulated and immersive environments that can be similar to or completely different from the real world, or may augment how the user 110 perceives the real world, such as augmented reality devices, mixed reality devices, or the like. In preferred embodiments, the AR system 120 is a device which augments reality of the user's surroundings, allowing the user to stay in context of their actual surroundings, view one or more physical items, such as products, or the like, while receiving an overlay of additional (or “augmenting”) information as a visual overlay on the user's actual surroundings.

In some embodiments, it is conceivable that the AR System 120 may be embedded within, or otherwise be a component of, the user device 130 (e.g., a mobile phone, wearable device, personal computer, or the like). In some embodiments, the AR system 120 may use either headsets or specialized glasses designed to be placed on the head of a user 110, or multi-projected environments to generate realistic images, sounds and other sensations that simulate a virtual or semi-virtual (augmented) environment. For example, the user may wear a headset or pair of glasses with a specialized display resolution which allows the user to easily view the screen at a minimal distance of inches or less. In some embodiments, a virtual reality environment of the user's typical shopping space, or the like, may be emulated, allowing the user to virtually visit their shopping space remotely.

A user 110 using AR equipment is able to look around the artificial world, move around in it, and interact with virtual features or items. In preferred embodiments, the user is not removed from their physical surroundings and immersed in a totally virtual environment. Rather, the user is able to receive additional information via the AR system 120 in a seamless, personalized fashion wherein the information is overlaid on or otherwise augments the user's view or perspective of their existing environment. It is understood that any graphical depictions generated by the augmented display system 300 may be designed to be displayed and interacted with a number of devices, including user device(s) 130 and one or more AR system(s) 120 (e.g., multiple AR systems 120 may be integrated remotely to display common information to multiple users in a conference setting, or the like, and may be oriented with respect to one another in a consistent manner in the augmented environment).

The third party system 140 may be any system that interacts with the other systems and devices of the system environment 100 including, but not limited to, merchant systems, third party data centers, access providers, data storage systems, third party user authentication systems, transaction systems, resource exchanges, web servers, or the like. For instance, in some embodiments, the managing entity system may need to contact one or more third party system(s) 140 in order to access resource accounts and resource exchanges, check price offers, reviews, or the like, or verify transactions or occurrences on a blockchain, share user data that may be pertinent to the experience of the user 110 as they interact with the augmented display system 300, or the like.

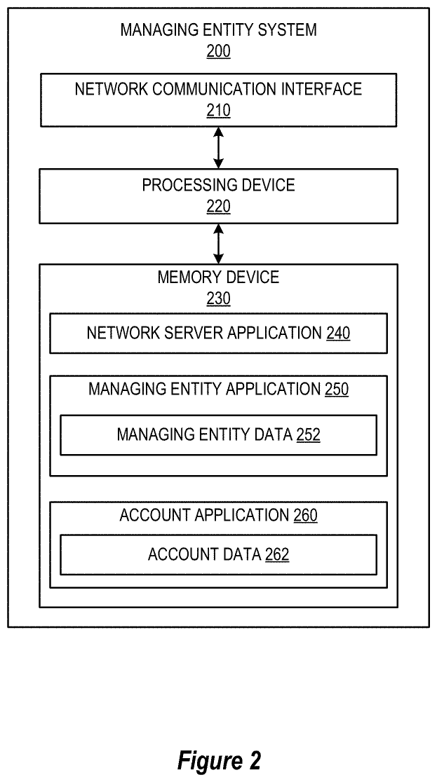

FIG. 2 provides a block diagram illustrating the managing entity system 200, in greater detail, in accordance with embodiments of the invention. As illustrated in FIG. 2, in one embodiment of the invention, the managing entity system 200 includes one or more processing devices 220 operatively coupled to a network communication interface 210 and a memory device 230. In certain embodiments, the managing entity system 200 is operated by a first entity, such as a financial institution.

It should be understood that the memory device 230 may include one or more databases or other data structures/repositories. The memory device 230 also includes computer-executable program code that instructs the processing device 220 to operate the network communication interface 210 to perform certain communication functions of the managing entity system 200 described herein. For example, in one embodiment of the managing entity system 200, the memory device 230 includes, but is not limited to, a network server application 240, a managing entity application 250 which includes managing entity data 252, an account application 260 which includes account data 262, and other computer-executable instructions or other data. The computer-executable program code of the network server application 240, the managing entity application 250, and/or the account application 260 may instruct the processing device 220 to perform certain logic, data-processing, and data-storing functions of the managing entity system 200 described herein, as well as communication functions of the managing entity system 200.

In one embodiment, the managing entity application 250 includes managing entity data 252. The managing entity data 252 may comprise user authorization information for one or more users that are customers of or are otherwise associated with the managing entity. The managing entity data 252 may additionally include a list of users, user roles, user access permissions, or other data such as information for establishing secure communication channels with authentication devices, user devices 130, AR systems 120, other entity systems or the like. In some embodiments, the managing entity data 252 further comprises system architecture information, such as resource usage by various devices or virtual machines (e.g., network bandwidth, memory, processing load, or the like), status of machines connected over an entity managed network, status of one or more server(s), status of one or more virtual machine session(s), status of applications, application permissions, identified issues, unauthorized access or unauthorized attempt notifications, or the like. The managing entity data 252 may also include user configurations for storing preferences related to the user's preferred experience with one or more AR systems 120.

In one embodiment, the account application 260 includes the account data 262. This account data 262 may include financial account information for one or more users associated with the managing entity system 200, such as customers of the entity. For example, the account data 262 may comprise account numbers, routing numbers, account balances, account rules, account preferences, billing information, credit information, loan information, digital wallet information, authentication information, savings goals, purchase history, dynamic resource value information, expected dynamic resource value information, historical and current resource exchange information or the like.

The network server application 240, the managing entity application 250, and the account application 260 are configured to invoke or use the managing entity data 252, the account data 254, or the like when communicating through the network communication interface 210 with the augmented display system 300, the one or more user device(s) 130, the AR System 120, and/or the third party system 140 in order to provide access to various information to be displayed on such devices.

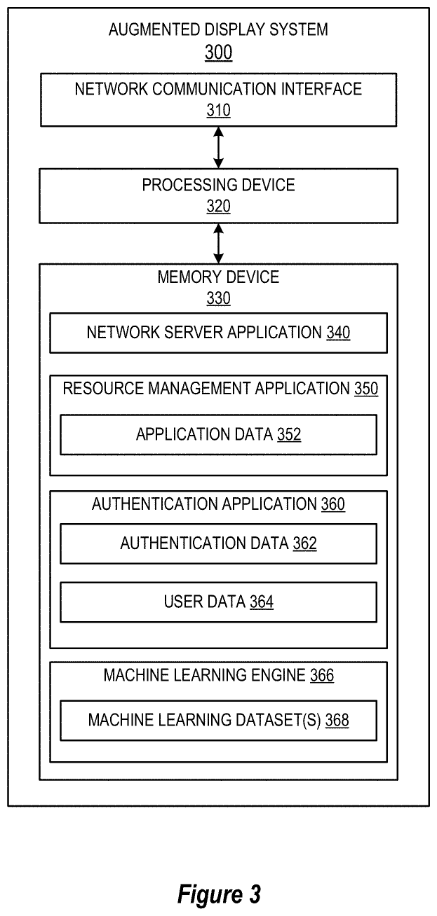

FIG. 3 provides a block diagram illustrating the augmented display system 300, in greater detail, in accordance with embodiments of the invention. As illustrated in FIG. 3, in one embodiment of the invention, the augmented display system 300 includes one or more processing devices 320 operatively coupled to a network communication interface 310 and a memory device 330. In certain embodiments, the augmented display system 300 is operated by a first entity, such as a financial institution, while in other embodiments, the augmented display system 300 is operated by an entity other than a financial institution.

It should be understood that the memory device 330 may include one or more databases or other data structures/repositories. The memory device 330 also includes computer-executable program code that instructs the processing device 320 to operate the network communication interface 310 to perform certain communication functions of the augmented display system 300 described herein. For example, in one embodiment of the augmented display system 300, the memory device 330 includes, but is not limited to, a network server application 340, a resource management application 350 which includes application data 352, an authentication application 360 which includes a authentication data 362 and user data 354, and other computer-executable instructions or other data. The computer-executable program code of the network server application 340, the resource management application 350, and/or the authentication application 360 may instruct the processing device 320 to perform certain logic, data-processing, and data-storing functions of the augmented display system 300 described herein, as well as communication functions of the augmented display system 300.

In one embodiment, the resource management application 350 includes application data 352. The application data 352 may comprise information for storing data or information associated with one or more users, their preferences, or their current application session. The application data 352 may additionally or alternatively include information for comparing data received from third party systems 140, managing entity system 200, or the like, such as account information, web services information, application usage information, login session information, user preferences, user role within an entity, or the like, to a stored database (e.g., a relational database) of associated information. In another embodiment, the application data 352 may include resource information, for instance, when the augmented display system 300 receives information from the managing entity system 200, the resource management application 350 can parse the data and display it via one or more user device(s) 130, or partially display certain information via one or more AR system(s) 120, based on the user's preferences or permissions (e.g., the augmented display system 300 may route sensitive data to the AR system 120 in order to reduce the ability for unauthorized viewing, or the like).

In one embodiment, the authentication application 360 includes authentication data 362 and user data 364. The authentication data 362 may include passwords, personal identification numbers, security questions, unique biometric information, dynamic two-factor authentication information, system security status, authentication images (e.g., security footage, or the like), stepped-up authentication information (e.g., tiered security information allowing users to access some data, but wherein they must provide additional authentication or verification information to access other, more sensitive information), or other authentication credentials (including secondary or stepped-up authentication credentials) associated with one or more users. This authentication data 362 can be accessed by the authentication application 360 to compare received authentication credentials to the stored authentication credentials when determining whether a user is authorized for viewing certain information, or for determining which information is displayed via one or more AR system(s) 120 automatically as an augmented overlay. For example, all users may see a baseline augmentation of the managing entity system 200 portal or interface, but only certain users who provide stepped-up authorization credentials via the AR systems 120 or user device 130 may receive a fully augmented view of certain information, such as user account information, system resources, system architecture or status, or the like. The user data 364 may comprise any additional information that the authentication application 360 may store for use in authenticating a user (e.g., establishing a contactless NFC chip for a user to authenticate via their user device 130, or the like).

The network server application 340, the resource management application 350, and the authentication application 360 are configured to invoke or use the application data 352, the authentication data 362, and the user data 364, when communicating through the network communication interface 310 with the managing entity system 200, the one or more user device(s) 130, the AR system 120, and/or third party systems 140.

The augmented display system 300 may also contain a machine learning engine 366 and machine learning dataset(s) 368. The machine learning engine 366 may store instructions and/or data that may cause or enable the augmented display system 300 to receive, store, and/or analyze data received by the managing entity system 200, user's device 130, or AR system 120. The machine learning engine may be a self-attention engine such as a generative adversarial network (GAN), which is a neural network that conducts deep learning to determine image classifications. Image classification can occur using a pixel-pixel approach, object to pixel approach, or an object to object approach, wherein the system may extrapolate or infer various features and data from a portion of an image. The machine learning engine 366 and machine learning dataset 368 may store instructions and/or data that cause or enable the augmented display system 300 to determine patterns and correlations within received user data, or to detect items in the physical world using deep neural network analysis of contours, shapes, or the like. In some embodiments, the machine learning dataset(s) 368 may contain data relating to user activity or device information, which may be stored in a user account managed by the managing entity system 200.

The machine learning engine 366 may receive data from a plurality of sources and, using one or more machine learning algorithms, may generate one or more output statistics stored in the machine learning dataset(s) 368. Various machine learning algorithms may be used without departing from the invention, such as supervised learning algorithms, unsupervised learning algorithms, regression algorithms (e.g., linear regression, logistic regression, and the like), instance based algorithms (e.g., learning vector quantization, locally weighted learning, and the like), regularization algorithms (e.g., ridge regression, least-angle regression, and the like), decision tree algorithms, Bayesian algorithms, clustering algorithms, artificial neural network algorithms, and the like. It is understood that additional or alternative machine learning algorithms may be used without departing from the invention. Data generated by the machine learning engine 366 may be utilized by the augmented display system 300 in order to inform recommendations for one or more users. For instance, machine learning engine 366 may identify that a certain percentage of users tend to purchase a particular product during a particular time of year, or when it is displayed in a particular location, or the like. When implementing a certain augmented reality aspect via AR system 120, it may recommend those certain aspects to other similar users.

In some embodiments, the machine learning engine 366 may receive a number of audio, video, or photograph data files containing metadata which identifies the files as originating from a specific source or containing the likeness of a specific product, or the like, and may package this data to be analyzed by the machine learning engine 366, as well as store the files in a catalog of data files in the machine learning dataset 368 or managing entity data 252 (e.g., files may be catalogued according to any metadata characteristic, including descriptive characteristics such as source, brand, description, or the like, or including data characteristics such as file type, size, sample rate, resolution, frequency patterns, length, or the like).

The machine learning engine 366 and machine learning dataset(s) 368 may store instructions and/or data that cause or enable the augmented display system 300 to generate, in real-time and based on received information, new overlay information about products identified via the data analysis module 260, and which include additional helpful information for the user. In some embodiments, the machine learning engine 261 and machine learning dataset(s) 262 may store instructions and/or data that cause or enable the managing entity system 200 to determine, in real-time and based on received information, a recommended resource actions to be taken to benefit one or more specific users based on their interests, goals, or resource account history, or the like, and text-based recommendations based on the recommended resource actions.

The machine learning dataset(s) 368 may contain data extracted or received from third party systems 140, managing entity system 200, or the like, via network 150. The augmented display system 300 may also contain metadata related to transactions (e.g., account, time, associated parties, merchants, products, data format, resource value, or the like). In some embodiments, the machine learning dataset(s) 368 may also contain data relating to user activity or device information, which may be stored in a user account managed by the managing entity system 200. In other embodiments, the database may contain a catalog of voice samples of known users, public figures, or the like, and may also contain system-generated machine learning output which allows the system to quickly access the voice pattern generation characteristics required to generate new audio files without the need for emulating a particular voice for which the system has already generated requisite data (or “learned” data).

In some embodiments, the machine learning engine 366 may be a single-layer recurrent neural network (RNN) which utilizes sequential models to achieve results in audio and textual domains. In some embodiments the machine learning engine 366 is a single-layer RNN with a dual softmax layer that is designed to efficiently predict 16-bit raw audio samples. RNN methods and systems are known in the art which can produce high-fidelity audio samples based on limited input in real-time or faster-than-real-time using a graphical processing unit (GPU) or central processing unit (CPU) (e.g., WaveRNN, WaveNET, or the like). One of ordinary skill in the art will appreciate that the use of these or other like-algorithms can enable the machine learning engine 366 to receive audio samples, perform efficient analysis of the audio samples, and generate new audio samples in a text-to-speech process to emulate one or more human voice characteristics of the speaker in the original audio sample.

Additionally, the machine learning engine 366 may serve an alternate or dual purpose of analyzing user resource account history, user preferences, user interests, or other user submitted or gathered data from managing entity system 200, third party system 140, or the like, in order to generate or locate intelligent recommendations tailored to the specific user. For instance, the machine learning engine 366 may consist of a multilayer perceptron neural network, recurrent neural network, or a modular neural network designed to process input variables related to one or more user characteristics and output recommendations or predictions relevant to the user. Given the nature of the managing entity system 200, particularly in embodiments where the managing entity system 200 is a financial institution, the machine learning engine 366 may have a large dataset of user account information, resource transaction information, account resource amount information, or the like, from which to draw from and discern specific patterns or correlations related to resource spending, saving, or the like which may be beneficial or of interest to particular users.

It is understood that such data may be anonymized or completely removed of identifying characteristics in preferred embodiments with no negative impact the system's ability to generate accurate output or prediction data given certain variables. For instance, users with a resource deposit amount of X, and a resource outflow amount of Y, and whose transaction histories indicate an interest in product category Z, may be interested in a particular product, service, or the like offered by the managing entity system 200 (e.g., a user who has a certain amount of disposable resources who is known to have purchased home-improvement products in the preceding weeks or months may be interested in a specialized line of home credit, an additional specialized savings account, or the like).

These intelligently generated recommendations may be related to products or services offered by one or more entities, while in other embodiments may be generally directed to beneficial tips or advice on increasing resource savings, resource inflow, or the like (e.g., a user which has a newly established resource savings account may be interested in saving a certain percentage of resource inflow per month, as recognized and recommended by the machine learning engine 366). In this way, the system may analyze user activity and resources on a per-user basis, accurately forecast beneficial suggestions or recommendations relevant to the user based on a larger dataset of numerous users, and automatically generate tailored recommendations for specific users. Recommendations or advice may also be generated in response to a question received from one or more users in real-time.

For instance, a sequence-to-sequence machine learning engine 366 may consist of two recurrent neural networks designed to process text-based questions and produce intelligent output in response by identifying relevant information based on the variables presented by a user 110. For instance, the user 110 may indicate an interest in increasing their resource savings, and the system may respond with a breakdown of the user's 110 resource outflow delineated by product or service categories. If resource outflow in a particular category is relatively higher than average, or relatively higher than that of other categories, the system may intelligently generate a recommendation to reduce resource outflow in that particular category. As opposed to transmitting the recommendation in a text-based format, the system may utilize a text-to-speech dataset in a specific voice pattern in order to communicate with the user in the voice which emulates a specific person, or the like.

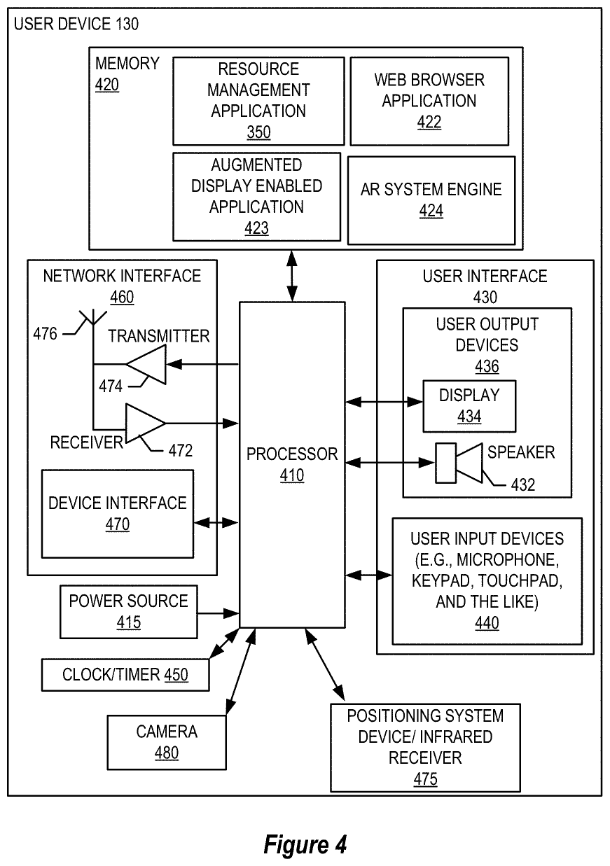

FIG. 4 provides a block diagram illustrating a user device 130 in more detail, in accordance with embodiments of the invention. In one embodiment of the invention, the user device 130 is a mobile telephone, laptop, desktop, or the like. Other types of computing devices may include augmented reality systems, televisions, monitors, consoles, smart assistants, or other internet-of-things connected devices, such as standalone cameras, video recorders, audio/video players, GPS devices, wearable devices, electronic kiosk devices, or the like.

Furthermore, it should be known that multiple user device(s) 130 may be owned by or accessed by the user 110 within the system environment 100 of FIG. 1, and these separate user device(s) 130 may be in network communication with each other and the other systems and devices of the system environment 100, such as augmented display system 300, managing entity system 200, and AR system 120. For example, a first user device 130 may comprise a mobile phone of the user 110 that includes an interface for working in concert with a second user device 130 that comprises a personal computer of the user 110 or an AR system 120 of the user 110. For instance, in some embodiments, a first user device 130 may be used for biometric authentication of a specific user, a second user device 130 may act as a desktop or laptop workstation of the specific user, and a AR system 120 may be enabled to augment the details transmitted to be displayed via the first or the second user device 130. In some embodiments, the AR system 120 may be configured to display virtual representations of one or more devices.

Some embodiments of the user device 130 include a processor 410 communicably coupled to such devices as a memory 420, user output devices 436, user input devices 440, a network interface 460, a power source 415, a clock or other timer 450, a camera 480, and a positioning system device 475. The processor 410, and other processors described herein, generally include circuitry for implementing communication and/or logic functions of the user device 130. For example, the processor 410 may include a digital signal processor device, a microprocessor device, and various analog to digital converters, digital to analog converters, and/or other support circuits. Control and signal processing functions of the user device 130 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the user device 130 to transmit and receive web content, such as, for example, location-based content and/or other web page content, according to a Wireless Application Protocol (WAP), Hypertext Transfer Protocol (HTTP), and/or the like.

The processor 410 is configured to use the network interface 460 to communicate with one or more other devices on the network 150. In this regard, the network interface 460 includes an antenna 476 operatively coupled to a transmitter 474 and a receiver 472 (together a “transceiver”). The processor 410 is configured to provide signals to and receive signals from the transmitter 474 and receiver 472, respectively. The signals may include signaling information in accordance with the air interface standard of the applicable cellular system of a wireless network. In this regard, the user device 130 may be configured to operate with one or more air interface standards, communication protocols, modulation types, and access types. By way of illustration, the user device 130 may be configured to operate in accordance with any of a number of first, second, third, and/or fourth-generation communication protocols and/or the like. For example, the user device 130 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, with LTE protocols, with 4GPP protocols, fifth-generation (5G) wireless communication protocols, millimeter wave technology, and/or the like. The user device 130 may also be configured to operate in accordance with non-cellular communication mechanisms, such as via a wireless local area network (WLAN) or other communication/data networks, such as a Bluetooth network standard for the short-range wireless interconnection of electronic devices.

As described above, the user device 130 has a user interface that is, like other user interfaces described herein, made up of user output devices 436 and/or user input devices 440. The user output devices 436 include a display 430 (e.g., a liquid crystal display, organic light emitting diode display (OLED), or the like) and a speaker 432 or other audio device, which are operatively coupled to the processor 410. In some embodiments, the display 430 may be a visual projection overlay type display for projection of information on a user's field of vision via a glass or polymer surface worn over the user's eyes. The user input devices 440, which allow the user device 130 to receive data from a user such as the user 110, may include any of a number of devices allowing the user device 130 to receive data from the user 110, such as a keypad, keyboard, touch-screen, touchpad, microphone, mouse, joystick, other pointer device, button, soft key, and/or other input device(s). The user interface may also include a camera 480, such as a digital camera or other optical sensor for receiving data on the user's surroundings. In some embodiments the camera 480 may be used to aid in determining the position of the user's view with respect to the display 434. For instance, the camera may be located at a fixed position with respect to the display 434, and may use image data in conjunction with data received from the positioning system deice/infrared receiver 475 in order to determine location or orientation of the user's gaze, or the location or orientation of one or more AR systems 120. In some embodiments, the AR systems 120 may contain specialized light emitting or infrared light emitting sources that interface with the user device 130 or physical items in the real world.

The user device 130 may also include a positioning system device/infrared receiver 475 that is configured to be used by a positioning system to determine a location of the user device 130. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate or exact geographical location of the user device 130. In other embodiments, the positioning system device 475 includes a proximity sensor or transmitter, such as an RFID tag, infrared receiver, or the like, that can sense or be sensed by devices known to be located proximate to the user device 130, such as one or more AR systems 120, or one or more products also containing an RFID take, an NFC chip, or the like. The infrared receiver may be used to track one or more infrared light emitting sources on the AR systems 120 in order to determine the exact orientation and change in orientation of a user's view with respect to the display 434.

In other embodiments, the augmented display system 300 may process information received from the AR system 120 in order to determine the orientation of the user's gaze. For instance, the AR system 120 may contain a gyroscope, infrared light sensor, Light Detection and Ranging (LiDAR) sensor, or the like, which may provide data to the augmented display system 300 for further processing. LiDAR systems of the AR system 120 may employ the use of Time of Flight (ToF) principles, wherein light is emitted at time t-0, hits an object, is reflected back, and is then measured by an array of sensors at time t-1. Based on knowledge about the speed of light, the measured interval—the ToF—can easily be converted into a precise distance. In some instances, considering how much light is returned, the size and shape of the object can also be determined, and may be used by the augmented display system 300 in order to generate virtual visualizations in the correct aspect ratio, size, perspective, or the like. Such calculations and analysis of the user's surroundings may be occurring continuously over a period of time as the user is engaging with the AR system 120. In some embodiments, analysis of the user's surroundings via processing of received LiDAR and video information may be performed locally on the AR system 120 via a positioning system 475 in conjunction with processor 410, or one or more specialized processors with dedicated onboard resources for processing positioning data.

The user device 130 further includes a power source 415, such as a battery, for powering various circuits and other devices that are used to operate the user device 130. Embodiments of the user device 130 may also include a clock or other timer 450 configured to determine and, in some cases, communicate actual or relative time to the processor 410 or one or more other devices.

The user device 130 also includes a memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which comprise computer-executable instructions/code executed by the processor 410 to implement the functions of the user device 130 and/or one or more of the process/method steps described herein. For example, the memory 420 may include such applications as a conventional web browser application 422, or the resource management application 350, an augmented display enabled application 423, or an AR system engine 424. These applications also typically instructions to a graphical user interface (GUI) on the display 430 that allows the user 110 to interact with the user device 130, the managing entity system 200, the augmented display system 300, one or more AR systems 120, or other devices or systems. The AR system engine 424 may include an attribute mapping engine, a notification engine, a local network recommendation engine, a resource advising engine, an offer generation engine, or the like, which act in concert to provide active or passive advice. During active advice, the AR system 120, which is a subset of user device 130, may notify or advise a user automatically based on a visual feed about a product, brand or the like. During passive advice, a user may select the product or brand using the AR system 120, and the AR system 120 will only respond to these selections instead of actively advising unprompted by the user.

In some embodiments, the augmented display enabled application may be used by the augmented display system 300 in order to track the user's input via one or more connected peripherals, or the like, and the augmented display system may transmit information to the user device 130 for display via the augmented display enabled application 423, while simultaneously transmitting information designed to overlay the augmented display enabled application 423 to one or more AR systems 120.

The resource management application 421 may comprise an application stored in the memory 420 that is configured to control and/or communicate with the mobile device system 400 to receive data or information (e.g., codes, signals, or the like) from the user device 130. The resource management application 421 may also be configured to communicate information received from the web browser application 422, and/or the augmented display enabled application 423. In some embodiments, the resource management application 421 may be configured to receive instructions from a separate system (e.g., the managing entity system 200, the augmented display system 300, a separate user device 130, and/or a third party system 140, such as a merchant system), and cause one or more components of the user device 130 to perform one or more actions. For example, the resource management application 421 may be configured to receive instructions for generating an alert on the user device 130 via audio or visual signals. The resource management application 421 may also cause the user device 130 to store or erase certain information located in the memory 420 based on executed resource management actions.

The memory 420 can also store any of a number of pieces of information, and data, used by the user device 130 and the applications and devices that make up the user device 130 or are in communication with the user device 130 to implement the functions of the user device 130 and/or the other systems described herein. For example, the memory 420 may include such data as transaction history data, positional data of the user device 130, biometric authentication information for the user 110, device identifiers for one or more other user devices 130, wireless network authentication information, or the like.

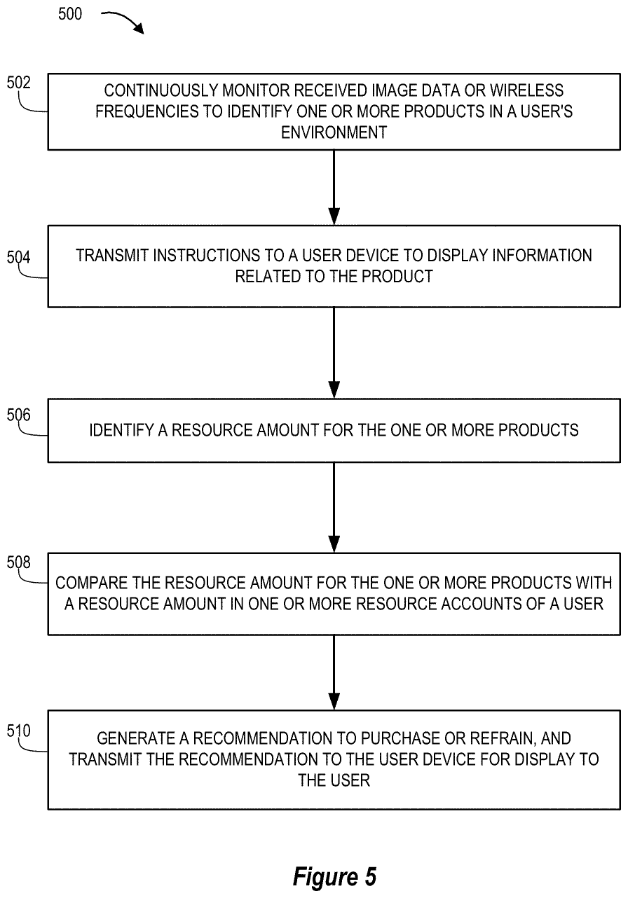

FIG. 5 provides a process flow 500 for providing a dynamically augmented display overlay, in accordance with embodiments of the invention.

The system 300 may receive imaging data from the AR system 120. The imaging data may be received in a constant stream of frames, such as a video stream, wherein each frame of the image data is analyzed by the system 300 in order to determine a frame of reference. In some embodiments, the imaging data received from AR system 120 may be in the form of LiDAR imaging data, which detects a distance of the user from nearby surroundings and allows the augmented display system 300 or the AR system 120 to determine the shape of one or more surrounding surfaces. This data steam may be constantly fed to the augmented display system 300 in order that it can react in real time to transmit relevant data to the AR system 120 for display in the user's visual frame of reference (e.g., as the user's head turns left, virtual objects in the user's right field of view may be phased out to coincide with the user's natural movement).

Additionally, the AR system 120 may transmit gyroscopic data in order for the augmented display system 300 to determine a speed and direction of movement of the user's head, and determine the frame of reference of the user. In some embodiments, the user may be prompted to do an initial 360 degree turn around the user's environment in order for the system to gain a reference of how large the space is, and what surfaces exist within the space, in order to accurately and seamlessly overlay virtual information. As the system forms a baseline for the user's surroundings, it may utilize one or more static reference points identified around the user in order to calculate an appropriate perspective view for virtual visual overlay of display information. The augmented display system 300 may contain a catalog of three dimensional renderings of potential objects to display via the AR system 120, and may determine an appropriate scale, perspective, or the like for those objects according to the distance, surface area, surface shapes, or the like surrounding the user in their space. For instance, measuring the distance of the AR system 120 from multiple spots on a flat desk or table surface adjacent the user, the augmented display system 300 can determine a perspective height of the user and infer a distance of the user's gaze with respect to each point on the flat surface. As an example, by measuring the distance of the AR system 120 from two points on a flat surface, the system may perform an angle calculation from a singular point of the sensor in order to triangulate a distance between the two points, and scale one or more virtual objects in relation. The system may repeat similar calculations for multiple points at known angular distances from one another in order to measure a slope of the surface from the user's perspective assuming the sensor is situated at or near the viewer's gaze (such as on either end of the frame of a pair of glasses, or the like).

The system 300 may perform a contour analysis and determine one or more appropriate locations for display of augmented overlay information based on the imaging data received from the AR system 120. For instance, one or more three dimensionally rendered virtual objects may be require a given amount of space, surface area, or the like, to be displayed via the AR system 120. The system 300 may periodically or continually update augmented overlay information transmitted to the AR system 120 based on received imaging data, user interaction data, and application data. For instance, the system 300 may alter the perspective view of a rendered virtual object based on the user's movement, may animate or dynamically alter the virtual object based on user interaction data from one or more user devices or the AR system 120, or may dynamically alter the virtual object based on application data such as data received from the user configuring the augmented environment (e.g., the user may upload a family picture for display in the augmented environment via an application on the user device 130, or the like).

As the AR system 120 receives application data from the user device(s) 130, the programs and products in use by the user 110 will inform the dynamically altered view produced by the augmented display system 300 for display on the AR system 120. For instance, in embodiments where the user is utilizing the resource management application to check their resource account balance, the AR system 120 may display an augmented or virtual reality rendering of their resource account breakdown, showing a percentage of monthly spending, yearly spending, or the like, and a target dispensable resource amount for a given time period.

It is understood that the visual aspects of any AR or VR rendering via the AR system 120 may be further tailored on a user-by-user basis. For instance, the augmented display system 300 may store user configurations which contain preferences for the user gathered by the managing entity system 200 or a third party system 140, either by the user 110 entering certain information into these systems, or by inference through the analysis of authorized gathering of user 110 device activity or history.

As shown in block 502, the process begins wherein the system continuously monitors received image data or wireless frequencies to identify one or more products in a user's environment. The system may perform a machine learning contour analysis, image identification analysis, scan a bar code, perform optical character recognition of text, or the like in order to identify one or more products in the user's vicinity. In other embodiments, one or more products may be equipped with a wireless transceiver, such as an NFC chip, RFID tag, or the like, which the augmented display system 300 may monitor for and recognize, and receive relevant information identifying the product, price, description, or the like. Additionally once the augmented display system 300 has identified a threshold level of detail about the product, such as product code, product name, product model number, or the like, the augmented display system 300 may also conduct a search of available information on the Internet, on a managing entity database, third party database, or the like, and intelligently source relevant product information such as product rating, price history fluctuation, comparison of price to similar products, warranty information, specifications of the product, or the like.

After this information has been obtained by the augmented display system 300, the system may transmit instructions to the AR system 120 to display information related to the product, as shown in block 504. Additionally, as shown in block 506, the augmented display system 300 identify a resource amount (e.g., price), for the product. This is compared to a resource amount in one or more resource accounts of the user, as shown in block 508. Not only will the system compare a total amount of resources in the user's resource account, but may also account for any “line” of resources extended to the user on a short term loan or credited basis. Additionally, as previously discussed, the augmented display system 300 may also conduct an analysis of the user's resource spending history, known recurring resource transfers or obligations, or the like, and identify if the user has the available resources to conduct a resource transfer for the product. Based on this information, the augmented display system 300 may generate a recommendation to purchase or refrain from purchasing, and will transmit the recommendation to the AR system 120 for display to the user.

As discussed, the AR system 120, which is a subset of user devices 130, may include an attribute mapping engine, a notification engine, a local network recommendation engine, a resource advising engine, an offer generation engine, or the like, which act in concert to provide active or passive advice. During active advice, the AR system 120, which is a subset of user device 130, may notify or advise a user automatically based on a visual feed about a product, brand or the like. During passive advice, a user may select the product or brand using the AR system 120, and the AR system 120 will only respond to these selections instead of actively advising unprompted by the user. Additionally, the AR system 120 may interface with one or more other AR system(s) 120 in the local area of the user, such as on the same local area network, or in the same vicinity wherein the systems may interface with a near-field connection. The AR system 120 may use data received from nearby devices in order to inform the user as to products, purchases, and offers that other users are receiving, which may be relevant if the user shares any characteristics or goals with the nearby users. It is also understood that the AR system 120 contains the processing power and capability to conduct remote edge computing, meaning that even though many of the machine learning and neural network analysis described above occurs on the augmented display system 300, the AR system 120 itself may share or be in control of any of these processes locally on-device in order to provide the user with more immediate feedback.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, or the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted, or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined, or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for situationally aware resource analysis and recommendation, the system comprising:
a memory device; and
a processing device operatively coupled to the memory device, wherein the processing device is configured to execute computer-readable program code to:
continuously monitor received image data or wireless frequencies to identify one or more products in a user's environment;
transmit instructions to a user device to display information related to the product on an augmented reality display;
identify a resource amount for the product;
compare the resource amount for the product with a resource amount in one or more resource accounts of a user;
generate a recommendation to purchase the product or refrain from purchasing the product; and
transmit the recommendation to the user device for display to the user.

2. The system of claim 1, wherein the received image data is analyzed using a generative adversarial network in order to identify a specific product by inference from its visual characteristics.

3. The system of claim 1, wherein wireless frequencies further comprise a near-field communication signal or a radio frequency identifier signal emitted from the one or more products in the user's environment.

4. The system of claim 1, further comprising:
monitoring a local network or the user's vicinity for other user devices;
identifying one or more other user devices in the user's vicinity;
requesting information from the one or more other user devices related to the product;
determining an average resource amount for the product; and
comparing the average resource amount for the product to a current resource amount for the product.

5. The system of claim 1, wherein the augmented reality display is an augmented reality system comprising a pair of glasses projecting an image directly in the user's line of sight.

6. The system of claim 1, wherein comparing the resource amount for the product with a resource amount in one or more resource accounts of a user further comprises identifying an amount of resources that the user has available based on resource transaction history and recurring resource transactions over a time period.

7. The system of claim 1, wherein generating a recommendation to purchase the product or refrain from purchasing the product further comprises identifying an alternative product of a different brand or model which the user has enough available resources to buy.

8. A computer program product for e situationally aware resource analysis and recommendation, the computer program product comprising at least one non-transitory computer readable medium comprising computer readable instructions, the instructions comprising instructions for:
continuously monitor received image data or wireless frequencies to identify one or more products in a user's environment;
transmit instructions to a user device to display information related to the product on an augmented reality display;
identify a resource amount for the product;
compare the resource amount for the product with a resource amount in one or more resource accounts of a user;
generate a recommendation to purchase the product or refrain from purchasing the product; and
transmit the recommendation to the user device for display to the user.

9. The computer program product of claim 8, wherein the received image data is analyzed using a generative adversarial network in order to identify a specific product by inference from its visual characteristics.

10. The computer program product of claim 8, wherein wireless frequencies further comprise a near-field communication signal or a radio frequency identifier signal emitted from the one or more products in the user's environment.

11. The computer program product of claim 8, further comprising:
monitoring a local network or the user's vicinity for other user devices;
identifying one or more other user devices in the user's vicinity;
requesting information from the one or more other user devices related to the product;
determining an average resource amount for the product; and
comparing the average resource amount for the product to a current resource amount for the product.

12. The computer program product of claim 8, wherein the augmented reality display is an augmented reality system comprising a pair of glasses projecting an image directly in the user's line of sight.

13. The computer program product of claim 8, wherein comparing the resource amount for the product with a resource amount in one or more resource accounts of a user further comprises identifying an amount of resources that the user has available based on resource transaction history and recurring resource transactions over a time period.

14. The computer program product of claim 8, wherein generating a recommendation to purchase the product or refrain from purchasing the product further comprises identifying an alternative product of a different brand or model which the user has enough available resources to buy.

15. A computer implemented method for situationally aware resource analysis and recommendation, said computer implemented method comprising:
providing a computing system comprising a computer processing device and a non-transitory computer readable medium, where the computer readable medium comprises configured computer program instruction code, such that when said instruction code is operated by said computer processing device, said computer processing device performs the following operations:
continuously monitoring received image data or wireless frequencies to identify a product in a user's environment;
transmitting instructions to a user device to display information related to the product on an augmented reality display;
identifying a resource amount for the product;
comparing the resource amount for the product with a resource amount in one or more resource accounts of a user;
generating a recommendation to purchase the product or refrain from purchasing the product; and
transmitting the recommendation to the user device for display to the user.

16. The computer implemented method of claim 15, wherein the received image data is analyzed using a generative adversarial network in order to identify a specific product by inference from its visual characteristics.

17. The computer implemented method of claim 15, wherein wireless frequencies further comprise a near-field communication signal or a radio frequency identifier signal emitted from the one or more products in the user's environment.

18. The computer implemented method of claim 15, further comprising:
monitoring a local network or the user's vicinity for other user devices;
identifying one or more other user devices in the user's vicinity;
requesting information from the one or more other user devices related to the product;
determining an average resource amount for the product; and
comparing the average resource amount for the product to a current resource amount for the product.

19. The computer implemented method of claim 15, wherein the augmented reality display is an augmented reality system comprising a pair of glasses projecting an image directly in the user's line of sight.

20. The computer implemented method of claim 15, wherein generating a recommendation to purchase the product or refrain from purchasing the product further comprises identifying an alternative product of a different brand or model which the user has enough available resources to buy.
